(19) United States
(12) Patent Application Publication
(10) Pub. No.: US 2004/0112950 A1
(43) Pub. Date: Jun. 17, 2004

(54) Secure stamp system

(76) Inventors: Flavio M. Manduley, Woodbury, CT (US); Michael Gilbert, White Plains, NY (US); Chunhua Li, Old Greenwich, CT (US); Gregg L. Kirk, Norwalk, CT (US); Charles F. Murphy III, Milford, CT (US); Michael Chenard, Mooresville, NC (US)

Correspondence Address: PITNEY BOWES INC., 35 WATERVIEW DRIVE, P.O. BOX 3000, MSC 26-22, SHELTON, CT, 06484-8000, US

(21) Appl. No.: 10/317,689

(22) Filed: Dec. 12, 2002

(51) Int. Cl. G06F 17/00

(52) U.S. Cl. 235/375

(57) ABSTRACT

A secure stamp system requires that a purchaser/user of stamps provide identifying information, such as name, address, telephone number, bank account information or biometric information at the time the stamps are purchased. This identifying information may be encoded or encrypted and printed on the stamp while corresponding information is stored in a memory that links the identifying information to an individual. Alternatively, the secure stamp system may have serial numbers printed thereon that are correlated to a purchaser/user. This enables the stamp to be traced to the individual who purchased the stamp. The stamps may have a predetermined operational life afterwhich the stamps are no longer valid.

### BACKGROUND

1. Field of the Invention

This invention relates generally to a secure stamp system and more particularly to a system for producing and tracking postal stamps, thereby enabling identification of a purchaser and/or user of a stamp.

2. Brief Description of the Art

While metered mail can be traced back to its originator, conventional postage stamps, which are placed on articles such as mailpieces, envelopes, letters, packages, parcels, postcards and other documents that are processed by the United States Postal Service (USPS) or other carrier service, cannot be traced back to an originator.

U.S. Pat. No. 6,385,504, entitled, “Mail Processing System With Unique Mailpiece Authorization Assigned in Advance of Mailpieces Entering Carrier Service Mail Processing Stream”, issued May 7, 2002, to Pintsov et al., relates to a mailing list that includes destination addresses for mailpieces to be submitted to a carrier service for delivery. A unique mailpiece identifier associated with mailpieces on the mailing list is generated by the carrier or other trusted third party. The unique mailpiece identifier is printed on the mailpiece with which it is associated. The mailpieces with the printed unique identifier are submitted to the carrier service and the carrier service obtains the printed unique identifier from the mailpiece. The obtained unique identifier from each said mailpiece is utilized to verify that data associated with the mailpiece has been processed by the carrier or trusted third party. When the unique number has been obtained from the mailpieces, the carrier service, if desired, may note this fact in the carrier records to prevent reuse of the unique identifier. The carrier service as part of issuing the unique identification may charge the mailer's account of other fund depository for the carrier service charges associated with the mailpiece and/or, assign a destination delivery code and/or, provide address hygiene for the mailpiece and/or change of address processing. When the unique identifier is obtained from the mailpiece, a delivery point destination code may be printed on the mailpiece, based on the corrected address. As an alternative, the destination delivery code may be provided to the mailer with the unique mailpiece identifier to be printed on the mailpiece by the mailer.

Thus, user-applied stamps, such as those purchased from a Post Office or other vendor, or kiosk and applied to a mailpiece and the like, have no way of identifying the purchaser and/or sender of a mailpiece. Thus, a person may place mail into the U.S. Postal System that contains poison, biohazardous material, anthrax or other substances that can cause injury or death to those who come in contact with the substance. One example of the above-described problems is the mailing of anthrax through the U.S. Postal Service using stamped mail.

Since postal stamps are anonymous, and there is no control over who purchases and/or uses the stamps, there is no way to track or trace the origin of a mailpiece, such as a letter.

Thus, what is needed is a method and apparatus to accurately identify and trace stamps that are placed on a mailpiece, letter, package, parcel, postcard or the like, which is carried via the USPS or private carrier such as UPS, FEDEX or the like.

### BRIEF SUMMARY OF THE INVENTION

Accordingly, one embodiment of the present invention is directed to a method for producing a traceable postage stamp. This method includes the steps of generating a plurality of postage stamps in a discrete quantity. Next a plurality of identifiers is generated and a particular identifier is assigned to each discrete quantity of postage stamps. The particular identifier is correlated to an origination, which may be a purchaser of postage stamps or the location at which the stamps were purchased. The postage stamps can be tracked as a function of the identifier back to the origination. Thus, a stamp, or quantity of stamps, is correlated to an individual who purchased the stamp(s).

Another embodiment of the present invention is directed to a method for producing a postage stamp. This method includes obtaining biometric information from a purchaser and encoding the biometric information onto a postage stamp. The biometric information may be encrypted and/or encoded and then decrypted and/or decoded to match the purchaser to a mailpiece, parcel, package, post card or the like.

Yet another embodiment of the present invention is directed to a method for producing a traceable postage stamp. This method includes generating a plurality of postage stamps in a discrete quantity. A plurality of identifiers is also generated and a particular identifier is assigned to each discrete quantity of postage stamps. The particular identifier is correlated to a purchaser of postage stamps such that the postage stamps may be tracked as a function of the identifier. A period of time may be established that the postage stamps are valid.

Yet another embodiment of the present invention is directed to a method of producing a traceable indicia. This method includes storing data in a storage medium and obtaining identifying data from a purchaser. The obtained identifying data is compared with the stored data and a determination is made whether there is a match between the obtained identifying data and the stored data. The obtained identifying data is encoded and an indicia is printed that includes the encoded data.

Yet another embodiment of the present invention is directed to a method of producing a postage stamp. This method includes storing data in a storage medium. A correlation is made between the obtained user data and the stored data. The obtained user data is encoded and the encoded data is printed on a postage stamp.

Yet another embodiment is directed to a postage stamp that has valuation data printed thereon and trace data representing information obtained from a purchaser of the postage stamp printed on the postage stamp.

### BRIEF DESCRIPTION OF THE DRAWINGS

FIG. 1 shows a diagram of a process to trace a mailpiece utilizing a secure database.

FIG. 2 shows a diagram of a process to trace a mailpiece from a sender to a recipient.

FIG. 3 shows a diagram of system to produce and trace a postage stamp.

FIG. 4 shows a block diagram of a system to produce and trace a postage stamp that utilizes a server address database.

FIG. 5 shows a flowchart of steps to generate an identifier associated with a quantity of postage stamps.

FIG. 6 shows a flowchart of steps to print biometric information on a postage stamp.

FIG. 7 shows a postage stamp with traceable information thereon.

### DETAILED DESCRIPTION OF THE INVENTION

Although metered mail can be identified by information printed by the metering device during the printing of the indicia, stamped mail does not have an efficient way to trace the mailpiece. Stamps are typically applied to mailpieces, which include envelopes, postcards, parcels, packages, bulk rate, first class, business return envelopes, and virtually any document carried through the United States Postal Service (USPS) or private carrier, such as UPS, FedEx, Airborne Express, or other carrier. The present invention provides a stamp that includes an identifier, which can be traced to the purchaser and/or location of sale of the stamp (origination). The identifier can include biometric information and/or other information about a purchaser of stamps. The identifier may have a predetermined period of validity, after which, the stamp becomes void.

In one embodiment, a secure database is populated with information provided by an individual that validates, or authorizes the individual to send stamped mailpieces through the USPS or private carrier. User information is stored in the secure database and can be linked to a mailpiece, which has identifying information either printed on the mailpiece or printed on an indicia of the mailpiece.

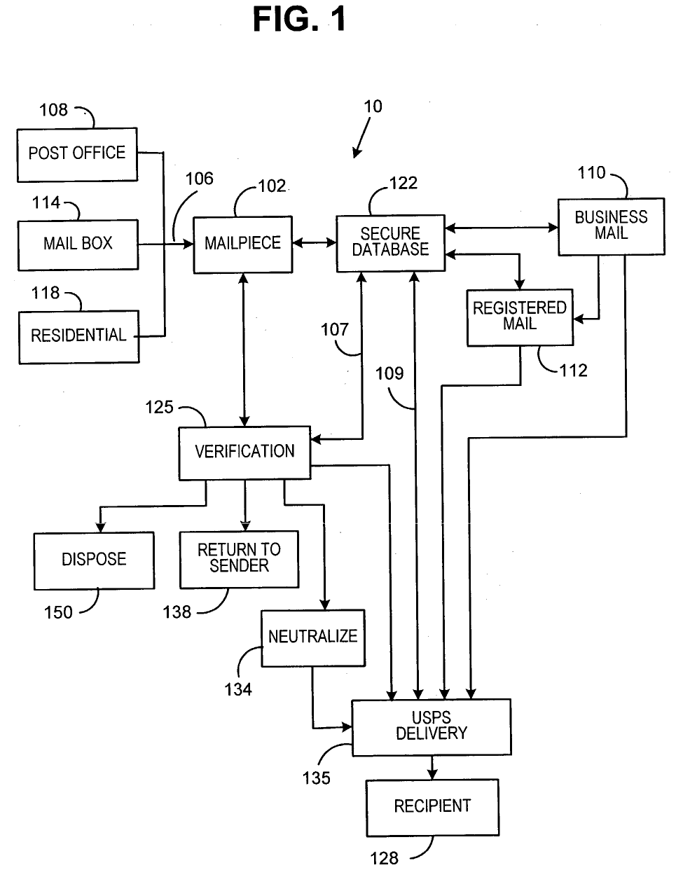

FIG. 1 shows a diagram 10 of a process to trace a mailpiece utilizing a secure database. Mailpiece 102 may be, non-identifiable and/or untraceable, such as a mailpiece distributed through the USPS having a stamp. The mailpiece 102 may have a stamp as described herein that enables information on the stamp to be traced to an individual purchaser and/or purchase location (origination). Post office location 108, may be either a USPS mailbox or a USPS facility. Block 118 represents a mailbox at a person's residence. This may be, for example, a mailbox at the residence or a common mailbox for an apartment complex or condominium association. Block 114 represents a USPS mailbox that is located remotely from the USPS facility and has mail picked up at a scheduled time. These sources of mailpieces generally 102 produce mailpiece data that can be scanned and data stored in a secure database 122.

Metered mail, or other traceable mailpieces may be generated as shown by blocks 110 and 112. These mailpieces have information printed thereon that can be stored in secure database 122.

Secure database 122 is in bidirectional communication with mailpiece data providing module 102 and business mail terminal 110 and registered mail terminal 112. The secure database 122 is used to store information obtained from a purchaser of the stamp or device that prints on a mailpiece, such as a meter. Secure database 122 is also in bidirectional communication with verification module 125 via a transmission medium, shown as line 107. Transmission medium is, for example, a communication line, telephone line, LAN, WAN, dedicated subscriber line or wireless network. The stamp (not shown) affixed to mail piece 102 has information that was obtained from a purchaser at the time the stamp was purchased. This information may be, for example, the purchaser's name, purchaser's address, purchaser's telephone number, purchaser's finger print, purchaser's facial scan, purchaser's social security number, purchaser's driver's license number, purchaser's height, weight, hair color or other identifying information. Other examples include information from an individual's passport, visa, alien registration or any other identifying information for that individual. It is also an embodiment of the instant invention, that the database is a national database, for example a database sponsored by the US Federal Government. This database may be populated with information obtained from individuals, as described above.

The information on the stamp may be compressed, or encoded using bar code technology or encrypted using encryption technology (or any combination of compression, encoding or encryption). An example of bar coding is two-dimensional bar coding, such as PDF-417. In an embodiment in which the data is encoded, a barcode scanner can decode the information and output the information to user, either on a computer monitor or an LCD of a hand-held scanner. An example of encryption is PGP (pretty good privacy) or a decryption key D₁ that corresponds to a key E₁. Any suitable encryption technique may be used to encrypt the data. RSA Security's Official Guide to Cryptography by Steve Burnett and Stephen Paine (McGraw-Hill 2600 Tenth Street Berkeley Calif. 94710) describes many possible encryption methods. The data is encrypted and printed on the stamp.

Verification module 125 obtains identifying data from a mailpiece and verifies that the mailpiece can be traced. The verification module 125 ensures that all mailpieces, either having a stamp, or metered indicia are traceable. Based on the results of processing performed by the verification module, the mailpiece may be disposed of (block 150) returned to sender (block 138) or neutralized (block 134). Also, the mailpiece, once authenticated, may be deposited into USPS delivery system 135 for delivery to recipient location 128. Other mail, such as metered mail and registered mail may enter USPS delivery system with or without being authenticated. Once in the delivery system, shown as USPS, the mailpiece 102 typically comes into contact with many other pieces of mail as well as USPS personnel and mail sortation and mail handling apparatus. The mailpiece can be traced by obtaining identifying information from the stamp or traceable indicia and comparing the identifying information to data stored in database 122. The delivery system 135 is in bi-directional communication with secure database 122 via communication medium 109. Communication medium 109 is, for example, any wireless or wire, or network medium that enables transmission of data. The data on a mailpiece, at any time in the delivery system, can be decrypted and compared to data stored in database 122 and displayed on a user terminal (not shown), thereby providing immediate information about the origination of the stamp, i.e., the purchaser, serial number or other identifying information.

The identifying information and/or serial number information may be printed on the stamp in a designated area, which does not interfere with the monetary indication. The obtained information is retained by the seller of the stamp, such as the USPS or private vendor. It can be stored in database 122 or other suitable memory or electronic storage medium that has sufficient memory capacity and speed. The database 122 can have its memory capacity augmented by utilizing additional electronic storage modules. In the event the purchaser uses a kiosk or other automated apparatus, the purchaser may be required to provide the necessary identifying information so that the output stamp(s) include the information thereon. The database 122 may obtain information that has been placed into the USPS mail delivery stream. The information may be stored in database 122 and may include various locations that the mailpiece 102 has passed. Therefore, in the event that a mailpiece has hazardous material, poison, acid or other undesired contents, the path of the mailpiece can be traced to determine personnel, equipment and apparatus that may have come into contact with the mailpiece 102.

In the event that a stamped mailpiece is desired to be traced, the encoded information is decoded and compared to the stored information in the database or other storage medium to determine the purchaser of the stamp. Since the purchaser of the stamp may misplace or lose the stamp, the identifying information on the stamp may have a pre-determined operational life, after which the stamp expires and cannot be used. Also, if a purchaser loses the stamps or the stamps are stolen, the purchaser can notify the appropriate authorities to have the stamps invalidated. The appropriate authority, who has access to database 122 can indicate that the selected stamps are no longer valid. Thus, when a stamp that has been designated as invalid, stolen or lost or unused for a predetermined period of time is scanned by the USPS or private carrier, the mailpiece is rejected and returned to the sender address. This reduces the use of stolen stamps to mail toxins and other hazardous materials.

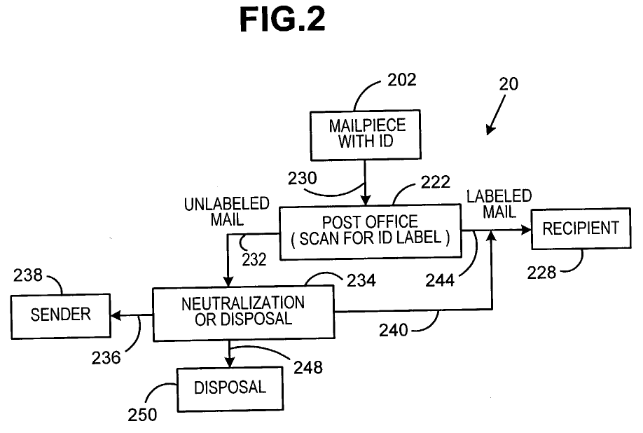

FIG. 2 shows a diagram 20 of a process to trace a mailpiece that has entered a delivery system. The mailpiece 202 includes an identifier, which is typically printed on a portion of the stamp or a portion of the mailpiece. The identifier may be, for example, a purchaser's name, purchaser's address, purchaser's social security number, purchaser's biometric information, such as fingerprint, facial data or other information. The identifier may also be a serial number associated with the stamp. The identifier is correlated to a person when the person purchases the stamps. The identifier may be encoded and/or encrypted and the information printed on a selected area of the stamp. The correlation is then stored in a common database or electronic medium.

Alternatively, the identifier could be a serial number on the stamp that is associated with a particular purchaser or origination of the stamp. For example, when a person purchases a stamp or book of stamps, the purchaser would be required to provide identifying information, such as name, address, telephone number, social security number, finger print data, facial scan data or other information that would link the purchaser to the stamp(s). Line 230 shows that the mailpiece 202 is deposited in the USPS block 222, either from a home mailbox or from a postal facility. The USPS obtains data from the stamp for example, by scanning the stamp, or other data recovery process. Thus, the USPS or other delivery service can ascertain that the stamp has indentifier information thereon. Line 244 shows that mail that is identified is delivered through the USPS to a recipient location 228.

The identified mail is delivered since the sender may be identified. Therefore, if the contents and/or envelope contain harmful materials, such as anthrax, biohazardous material, acid, poison or the like, the purchaser of the stamp on the mailpiece can be identified.

Line 232 shows that mail that is not identified by the USPS may be carried to a neutralization and/or disposal location block 234. This location may be for example, an air-tight container, infrared station or incinerator that can either sanitize the mailpiece or dispose of it.

Line 236 shows that neutralized mail may be sent to the sender, block 238. Line 240 shows that neutralized mail may also be sent to the recipient, block 228. Line 248 shows that mail that is not neutralized is disposed of, as shown in block 250.

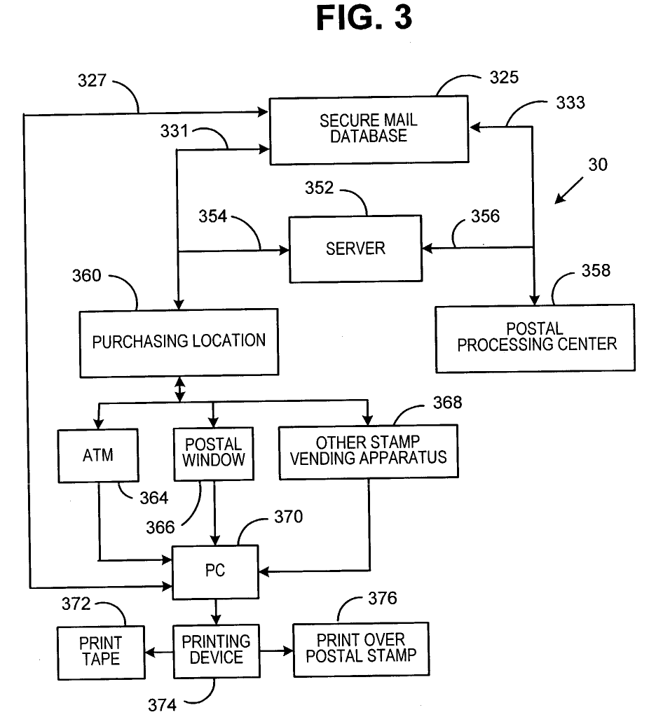

FIG. 3 shows a diagram of system 30 to produce and trace a postage stamp. The system 30 superimposes a printed secure-coded indicia over a postage stamp at the time of purchase. The secure-coded indicia may, for example, include purchaser's name, purchaser's address, purchaser's driver's license information, an ATM identification number when a bank card or credit card is used to purchase the stamp, or biometric information obtained from the purchaser, such as finger print data, or a facial scan.

The system is implemented by obtaining a form of identification from a user or purchaser. As stated above, this information may be biometric information such as fingerprint or facial data, or name, address, account number (such as bank account number, credit card number) or other identifying information. The obtained information can be verified by requiring the purchaser to present a form of identification, such as a photo i.d. or driver's license.

A purchaser at a terminal such as an ATM 364, postal window 366 or other stamp vending location 368, such as a kiosk provides the identifying information.

The information obtained from the purchaser is transmitted to a purchasing location 360 that correlates the identifying information obtained from a purchaser to a particular quantity of stamps. This information is transmitted to a storage location 352, which is illustrated by way of example as a server. The transmission can be accomplished via bi-directional communication line 354. This line can be a telephone line, dedicated line or wireless transmission.

Once the identifying information has been associated with a particular quantity of stamps the identifying information can be stored in PC 370 and the identifying information is printed on the stamps (shown in blocks 374, 376), or tape (shown in block 372), typically in a selected area of the stamp. The stamps are issued to the purchaser, either by a human operator or dispensed through an automated dispensing apparatus.

A secure database 325 is used to store user data. Thus, when a user is authorized to purchase stamps, that information is stored in database 325. The database 325 is in bidirectional communication with server 352 and PC 370 as illustrated by lines 331 and 327, respectively. The secure mail database is also in bidirectional communication with postal processing center 358, via transmission medium 333. Other bi-directional transmission media are shown as lines 354, and 356.

Postal processing center 358 is one example of how the identifying information on the stamp or tape can be retrieved and compared to the stored data stored in location 352. Line 356 shows that data is transmitted bi-directionally between postal processing center 358 and server 352. Line 356 is typically a communication line or wireless transmission means. Center 358 may have, for example, bar code scanners that decode bar coded information or a decryption device to decrypt the identifying information (bar code scanners and decryption device not shown). This information can be compared to stored information to identify the purchaser of a particular stamp. For example, if a mail piece is determined to have toxins, threatening content, anthrax or other poisonous material or otherwise desired to be traced, the mailpiece can be traced by scanning, decoding and/or decrypting the identifying information printed on the stamp and comparing the data to purchaser information stored in a database. Alternatively, in an embodiment in which the stamp has a serial number that is correlated to a purchaser, the serial number can be compared to data in the database to ascertain the purchaser of that stamp. This enables the mailpiece to be traced back to the purchaser of the stamp that is on the mailpiece.

It is also an embodiment that the server is in secure bidirectional communication with the meter (business mail) modulel. This enables the meter to download information and print the information on a medium, such as an envelope or tape.

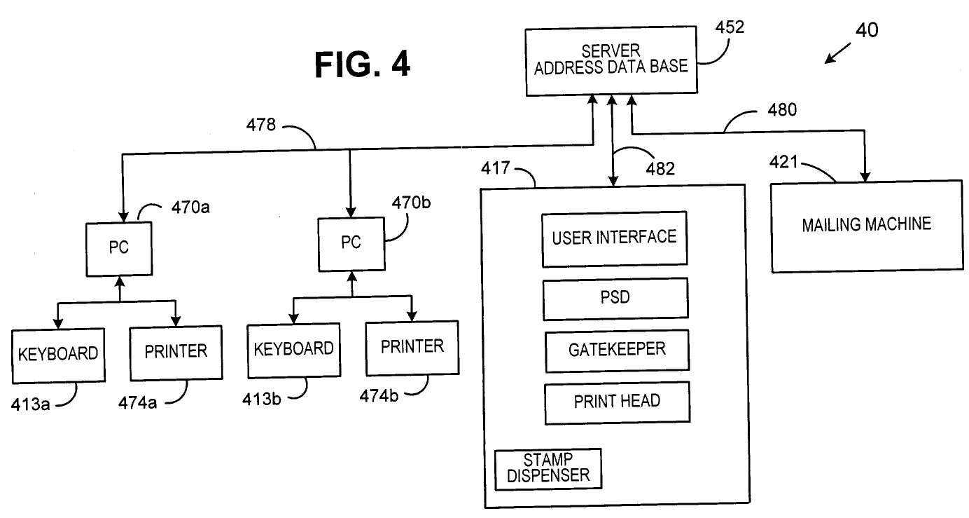

FIG. 4 shows a block diagram of a system 40 to produce and trace a postage stamp that utilizes a server address database 452. Terminals 470(a) and 470(b) (generally 470) are typically personal computers (PCs) having processing capabilities and memory (not shown). The PCs 470 are typically coupled to a printer 474 and a keyboard 413. The terminals 470 are also coupled to server address database 452 via transmission line or wireless communication means, shown as line 478. A user at terminal 470 can print postage by downloading information to the PC 470 and printer 474. This postage includes identifying information that is printed on the stamp. The user at terminal 470 must provide requested information that links the user to a selected quantity of stamps that the user prints.

Server address database 452 contains address data and is coupled to PCs 470 as shown by line 478. This coupling is typically a transmission wire (such as DSL or ISDN), phone line, or wireless connection. The server address database 452 has sufficient memory to store purchaser information correlated to information printed on a stamp or tape.

Server address database 452 is also coupled to a postage producing device 417 via transmission means 482, which may be a dedicated line (such as DSL or ISDN), phone line, or wireless connection. The postage producing device 417 may be for example a kiosk, ATM or other automated postage vending apparatus. This device has a user interface, and a postal security device (PSD). A user can input identifying information via the user interface. The postage producing device 417 can print postage on a tape, which is applied to a mailpiece or dispense stamps. The printed postage also includes identifying information that is provided by a user via the user interface.

Server address database 452 is coupled to mailing machine 421 via transmission means 480. The mailing machine 421 applies a secure stamp (i.e., a stamp that includes identifying information) to an envelope. Alternatively, the mailing machine 421 may have envelopes with pre-printed stamps thereon. The pre-printed stamps are linked to user data that is obtained from a user.

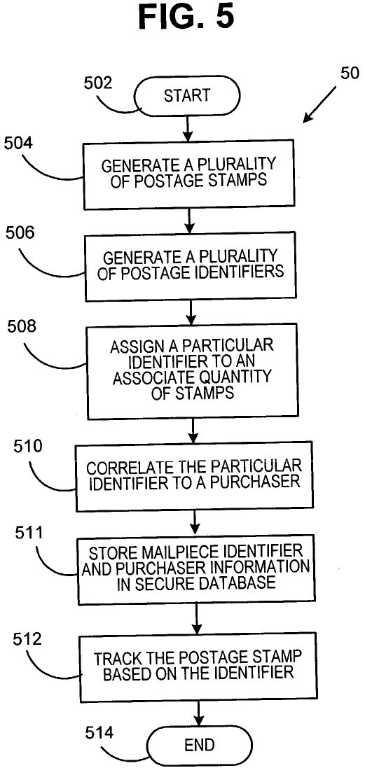

FIG. 5 shows a flowchart 50 of steps to generate an identifier associated with a quantity of postage stamps. The flowchart begins with start block 502. In block 504 a plurality of postage stamps are generated. The stamps can be of various denominations, such as post cards, bulk mail or any desired amount. In block 506 a plurality of identifiers is generated. In block 508, a particular identifier is associated with a quantity of stamps. In block 510, the identifiers are associated with a purchaser. This association enables a stamp to be linked to a purchaser. In block 511, mailpiece identifying information, such a code or other representation is stored with purchaser information, which has been provided by a purchaser and verified. Block 512 shows that the postage stamp may be traced based on the identifier that is on the stamp. The tracing function is performed by decoding, decrypting or reading data from the stamp and comparing the data to stored data. Block 514 is an end block.

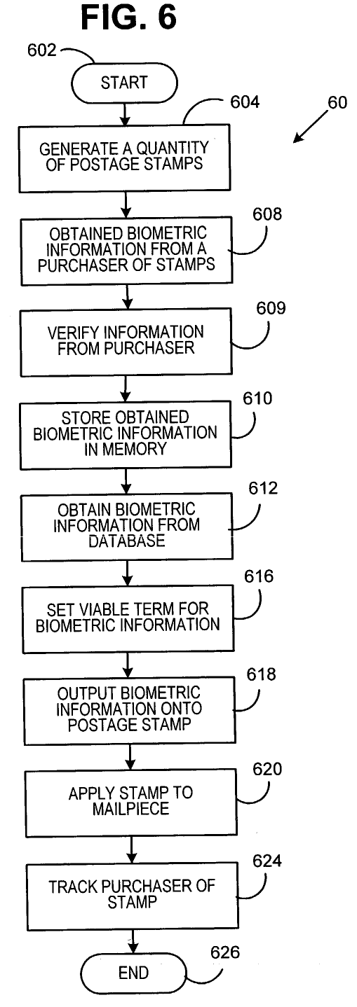

FIG. 6 shows a flowchart 60 of steps to print biometric information on a postage stamp. The flowchart begins with start block 602. In block 604 a quantity of postage stamps are generated. In block 608, biometric information is obtained from a purchaser of stamps. Block 609 shows that the purchaser's information is verified. In block 610, the biometric information acquired from a purchaser of stamps is stored in a memory. In block 612, biometric information is obtained. In block 616, a viable term is set for the biometric information. The viable term is a function of the period of time that the stamp is valid. In block 618, the biometric information or other identifying information is incorporated onto postage stamps.

In block 620, the stamp is applied to a mailpiece. Block 624 shows that the purchaser of the stamp can be determined by comparing the identifying information to data stored in a database. Block 626 is an end block.

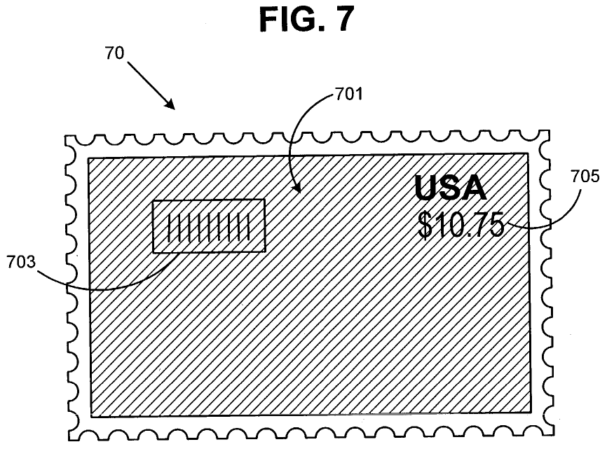

FIG. 7 shows a postage stamp 70 with traceable information embedded, encoded and/or printed thereon. The postage stamp is generally shown as 701 and includes a value 705 and identifying information 703. The identifying information 703 is a representation of information obtained from a purchaser. The identifying information can be linked to the purchaser and thereby identify the purchaser.

While the invention has been described in terms of a secure stamp, it is also an embodiment of the present invention that a purchaser of a postage meter would register information, such as name, address, telephone number, bank account information, credit card account information, biometric information or other identifying information that could be used to trace metered mail to a specific individual. The serial number or other identifying information related to the meter could be printed on mailpieces originating from the meter. The same techniques described herein in relation to stamps would also apply to correlating a meter to an individual.

It is also an embodiment of the instant invention that the information on the mailpiece and/or information related to a meter correlates to identification data that is stored in a database, such as a federally sponsored database as described herein.

While various embodiments of the invention have been described above, it is contemplated that many changes and modifications may be made to the invention without departing from the scope and spirit of the invention as disclosed.

What is claimed is:

1. A method for producing a traceable postage stamp comprising the steps of:
generating a plurality of postage stamps in a selected quantity;
generating a plurality of identifiers;
encoding the plurality of identifiers;
assigning a particular identifier to a discrete quantity of postage stamps;
correlating the particular identifier to a purchaser of postage stamps;
printing the particular identifier on selected stamps; and
tracking the postage stamps as a function of the identifier.

2. The method of claim 1, wherein the identifier is biometric information.

3. The method of claim 1, wherein the identifier is encoded.

4. The method of claim 1, wherein the identifier is encrypted.

5. The method of claim 1, wherein the identifier is compressed.

6. The method of claim 1, where the identifier is a serial number.

7. A method for producing a postage stamp comprising the step of:
obtaining biometric information from a purchaser; and
encoding the biometric information onto a postage stamp.

8. A method for producing a traceable postage stamp comprising the steps of:
generating a plurality of postage stamps in a selected quantity;
generating a plurality of identifiers;
assigning a particular identifier to a discrete quantity of postage stamps;
correlating the particular identifier to a purchaser of postage stamps;
tracking the postage stamps as a function of the identifier; and
establishing a period of time that the postage stamps are valid.

9. A method of producing a traceable indicia comprising the steps of:
storing data in a storage medium;
obtaining user data from a user;
comparing the obtained user data with the stored data;
determining a match between the obtained user data and the stored data;
encoding the obtained user data; and
printing an indicia that includes the encoded data.

10. A method of producing a postage stamp comprising the steps of:
storing data in a storage medium;
obtaining user data from a user;
comparing the obtained user data with the stored data;
determining a match between the obtained user data and the stored data;
encoding the obtained user data; and
printing the encoded data on a postage stamp.

11. A method of tracing a mail piece having a postage stamp comprising:
obtaining data from the postage stamp;
comparing the obtained data to data that is stored in memory;
outputting a signal indicating a match between the data obtained from the postage stamp and the data stored in memory; and
recording a path of the mailpiece through a delivery system.

12. A postage stamp comprising:
valuation data printed on the postage stamp; and
trace data representing information obtained from a purchaser of the postage stamp printed on the postage stamp.

13. The postage stamp as claimed in claim 12, wherein the tracing data is biometric information.

14 The postage stamp as claimed in claim 12, wherein the tracing data is encoded information.

15. The postage stamp as claimed in claim 13, wherein the tracing data is address information.

16. The postage stamp as claimed in claim 13, wherein the tracing data is purchaser name information.

17. The postage stamp as claimed in claim 13, wherein the tracing data is correlated to a database.

18. A method for producing a traceable indicia comprising the steps of:
obtaining purchaser information from a purchaser;
correlating the purchaser information with meter information;
storing the purchaser information; and
printing traceable indicia using the meter.

19. The method as claimed in claim 18, wherein the meter information is a serial number.
